(19) United States
(12) Patent Application Publication
(10) Pub. No.: US 2014/0228221 A1
(43) Pub. Date: Aug. 14, 2014

(54) SUPERCONDUCTING ROTATING MACHINES COOLING APPARATUS USING HEATING PIPE

(71) Applicants: Hyun-Jang Shin, Yongin-si (KR); Keun-Woong Kim, Yongin-si (KR); Wan-Gi Kim, Seoul (KR)

(72) Inventors: Hyun-Jang Shin, Yongin-si (KR); Keun-Woong Kim, Yongin-si (KR); Wan-Gi Kim, Seoul (KR)

(73) Assignee: HYUNDAI HEAVY INDUSTRIES CO., LTD., Ulsan (KR)

(21) Appl. No.: 14/128,886

(22) PCT Filed: Jul. 10, 2012
(86) PCT No.: PCT/KR2012/005451

§ 371 Date: Dec. 23, 2013

(30) Foreign Application Priority Data
Oct. 28, 2011 (KR) 10-2011-0111435

(51) Int. Cl. H02K 9/22; H02K 55/00

(52) U.S. Cl. CPC H02K 9/22; H02K 55/00
USPC 505/163; 310/52

(57) ABSTRACT

The present invention relates to superconducting rotating machines cooling apparatus using a heating pipe. According to the superconducting rotating machines, a shaft is fitted and coupled into a center of a central body, a stator yoke is coupled to the periphery of the central body, a superconducting coil is wound around a bobbin mounted on the stator yoke, and a cold head for cooling the superconducting coil is coupled to an end of the shaft. Also, in the superconducting rotating machines using the heating pipe, the heating pipe may be disposed on one surface from among all the surfaces of the bobbin around which the superconducting coil is wound or a winding portion of the superconducting coil so that the bobbin has a uniform temperature distribution therein.

### TECHNICAL FIELD

The present invention relates to a superconducting rotating machines cooling apparatus using a heating pipe, and more particularly, to a superconducting rotating machines cooling apparatus using a heating pipe, in which the heating pipe is installed at a bobbin on which a superconducting coil is wound or a winding portion of the superconducting coil, thereby considerably reducing a temperature difference between a near portion to and a far portion from a cold head, and thus it is possible to embody a superconducting cooling method by conduction and also rapidly respond to a momentary temperature change.

### BACKGROUND ART

Most stators of conventional motors are cooled through natural convection or forced convection, and some of them are cooled through water cooling or oil cooling.

In case of air cooling, current density which can be flowed through a stator coil is relatively lower than that in the water cooling or oil cooling. However, the air cooling by natural convention does not need a separate cooling apparatus, and the air cooling by forced convection needs only installation of a cooling fan (blower).

In case of water (oil) cooling, it is used in a relatively high capacity system of 1000 horsepower or more, and current density which can be flowed through a stator coil is relatively higher than that in the air cooling. However, it has a very complicated cooling structure.

Generally, as shown in FIG. 1, the water cooling or oil cooling in a conventional motor does not use a method of directly cooling a stator coil 1 generating the most heat, but use a method of cooling a stator core 2 enclosing the coil and removing the generated heat through heat transfer with the stator coil.

Therefore, a passage 3 through which water or oil for cooling the stator flows forms a structure for cooling a stator yoke core.

In the conventional motor, since the stator coil is enclosed by a metal core through which heat is transferred smoothly, the stator coil can be cooled sufficiently, if the cooling passage is just defined at a stator yoke portion. Meanwhile, superconducting rotating machines such as superconducting motor or superconducting generator uses a superconducting coil which can generate a strong magnetic field without using of the core.

Since a conventional motor uses a coil formed of copper, it is difficult to obtain a desired output, if a core is not used, and a gap between a stator core and a rotor core is very small in order to maximize magnetic flux interlinkage of a stator coil and a rotor coil.

Therefore, the stator coil is inserted into a slot formed of the core, thereby minimizing the gap between the stator core and the rotor core.

However, since the magnetic field is concentrated to the slot formed of the core, an AC loss at the slot is larger than that at other portions, when the magnetic field generated by the rotor rotates, and also permeability of the slot portion is different from that of the coil portion, and such a difference causes a distortion rate of generation voltage waveform to be increased.

In order to solve the problem in the conventional apparatus, the stator slot of the superconducting rotating machines is not formed of the core, but formed of a non-magnetic material such as fiber-glass reinforced plastics (FRP).

In this case, there are some advantages that the loss in the slot portion is prevented and the generation voltage waveform is very sinusoidal. However, since thermal conductivity of the FRP is much lower than that of the metal core, there is also a disadvantage that the heat generated from the stator coil cannot be easily discharged.

For this reason, in case of the superconducting rotating machines, one of the most important factors is to maintain a cryogenic state.

A method of cooling the superconducting coil as a core part of the superconducting rotating machines may be divided into a cooling method using a helium line and a cooling method by only conduction without the helium line.

In the cooling method using the helium line, an advantage is to uniformly distribute temperature of a superconducting wire material, and a disadvantage is to have a very complicated structure in which the helium line should be provided and a circulator for circulating helium should be also installed.

In the cooling method by conduction, in which a conduction cooling plate is disposed at a cold head portion of a cooler, and a conduction line is provided up to the superconducting coil, thereby performing the cooling operation only by conduction. Herein, an advantage thereof is to have a very simple structure and excellent durability, and a disadvantage thereof is that cooling speed is slow and temperature distribution of a bobbin on which the superconducting coil is wound is not uniform.

FIG. 1 illustrates conventional superconducting rotating machines cooling apparatus. A shaft 1 is fitted and coupled into a center of a central body 2, a stator yoke 3 is coupled to the periphery of the central body 2, a superconducting coil 5 is wound on a bobbin 4 mounted on the stator yoke 3, a two-stage cold head 6 for cooling the superconducting coil 5 is coupled to an end of the shaft 1, a radiation shield 11 is formed between the cold head 6 and the bobbin 4 in order to maintain an airtight state, a first stage portion 7 of the cold head 6 cools the radiation shield 11, and a second stage portion 8 of the cold head 6 is connected to the superconducting coil 5 through a copper braided wire 9, a copper plate 10, and another copper braided wire 9 in order to cool the superconducting coil 5.

Here, the copper braided wire 9 is used for reducing stress due to a sudden temperature difference.

However, in the conventional superconducting motor cooling apparatus, there is a problem that a temperature difference between a near portion to and a far portion from a cold head is very large.

### DISCLOSURE

### Technical Problem

The present invention is directed to providing a superconducting rotating machines cooling apparatus using a heating pipe, in which the heating pipe is installed at a bobbin on which a superconducting coil is wound or a winding portion of the superconducting coil, thereby considerably reducing a temperature difference between a near portion to and a far portion from a cold head, and thus it is possible to embody a superconducting cooling method by conduction and also rapidly respond to a momentary temperature change.

### Technical Solution

One aspect of the present invention provides a superconducting rotating machines cooling apparatus using a heating pipe, including: a shaft fitted and coupled into a center of a central body; a stator yoke coupled to a periphery of the central body; a superconducting coil wound on a bobbin mounted on the stator yoke; and a cold head for cooling the superconducting coil coupled to an end of the shaft, wherein the heating pipe is installed at one or multiple surfaces of all surfaces of the bobbin on which the superconducting coil is wound or at a winding portion of the superconducting coil so that temperature at the whole bobbin is uniformly distributed.

The heating pipe may be installed at multiple surfaces of all surfaces of the bobbin on which the superconducting coil is wound.

### Advantageous Effects

According to the present invention, as described above, a heating pipe is installed at a bobbin on which a superconducting coil is wound or a winding portion of the superconducting coil, thereby considerably reducing a temperature difference between a near portion to and a far portion from a cold head, and thus it is possible to embody a superconducting cooling method by conduction and also rapidly respond to a momentary temperature change.

### DESCRIPTION OF DRAWINGS

FIG. 1 illustrates conventional superconducting rotating machines cooling apparatus.

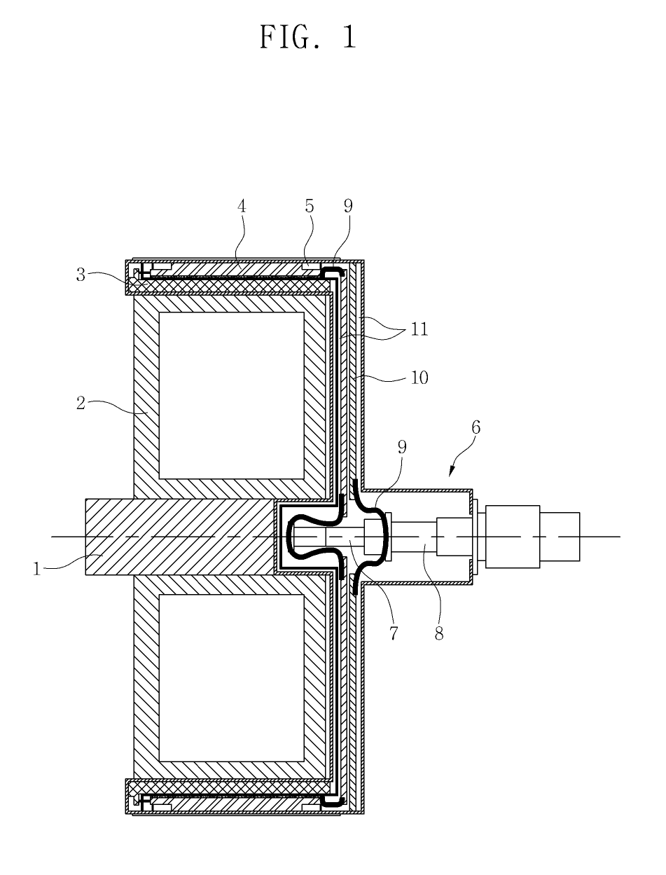

FIG. 2 illustrates superconducting rotating machines cooling apparatus according to the present invention.

FIG. 3 illustrates a connection state of a bobbin and a cold head applied to the present invention.

### MODES OF THE INVENTION

Hereinafter, exemplary embodiments of the present invention will be described in detail with reference to the accompanying drawings.

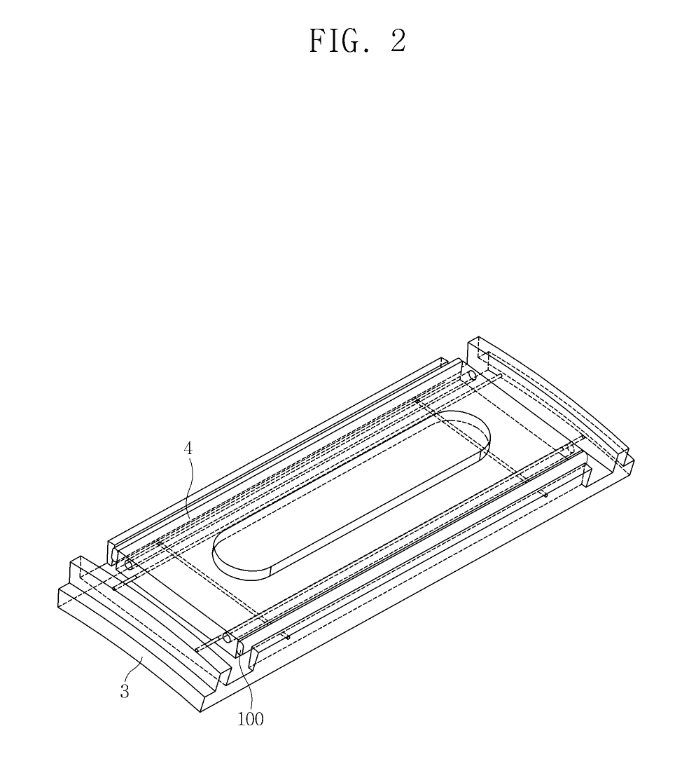

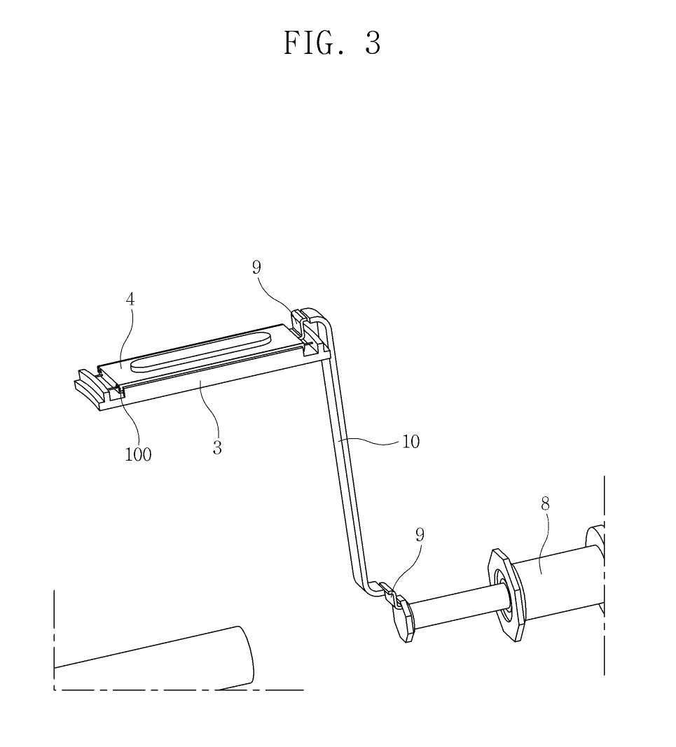

FIG. 2 illustrates superconducting rotating machines cooling apparatus according to the present invention, and FIG. 3 illustrates a connection state of a bobbin and a cold head applied to the present invention.

Referring to FIGS. 2 and 3, in superconducting rotating machines cooling apparatus using a heating pipe according to an embodiment of the present invention, a shaft 1 is fitted and coupled into a center of a central body 2, a stator yoke 3 is coupled to the periphery of the central body 2, a superconducting coil 5 is wound on a bobbin 4 mounted on the stator yoke 3, and a cold head 6 for cooling the superconducting coil 5 is coupled to an end of the shaft 1. A heating pipe 100 is installed at one or multiple surfaces of all surfaces of the bobbin 4 on which the superconducting coil 5 is wound or at a winding portion of the superconducting coil 5 so that temperature at the whole bobbin 4 is uniformly distributed.

In other words, as shown in FIG. 2, if the heating pipe 100 is installed at one or multiple surfaces of all surfaces of the bobbin 4 on which the superconducting coil 5 is wound or at a winding portion of the superconducting coil 5, a chill conducted from the cold head 6 is rapidly transferred to the whole bobbin 4 through the heating pipe 100, and thus the temperature of the bobbin 4 becomes entirely uniform.

FIG. 3 illustrates the connection state of the superconducting coil 5 wound on the bobbin 4 and a second stage portion 8 of the cold head 6. A copper braided wire 9 is connected to the second stage portion 8 of the cold head 6, and another copper braided wire 9 is connected to the bobbin 4 on which the superconducting coil 5 is wound, and the copper braided wires 9 are connected to each other through a copper plate 10 so that the chill generated from the second stage portion 8 of the cold head 6 can be rapidly transferred to the bobbin 4 through the copper braided wires 9 and copper plate 10, thereby quickly cooling the superconducting coil 5.

Further, since the chill transferred through the cold head 6 is rapidly transferred to the whole bobbin 4 through the heating pipe 100 installed at one or multiple surfaces of all surfaces of the bobbin 4 or at the winding portion of the superconducting coil 5, the whole portions of the bobbin 4, which are even far from or near to the cold head 6 have entirely uniform temperature distribution.

Until now, the technical spirit of the superconducting rotating machines cooling apparatus according to the present invention is described with reference to the drawings, but the present invention is not limited to this.

While the present invention has been described in detail, it should be understood that various changes, substitutions, and alterations can be made hereto without departing from the spirit and scope of the invention as defined by the appended claims.

### INDUSTRIAL APPLICABILITY

According to the present invention, the heating pipe installed at the bobbin on which the superconducting coil is wound or the winding portion of the superconducting coil can be efficiently applied to the superconducting rotating machines cooling apparatus, thereby considerably reducing the temperature difference between a near portion to and a far portion from the cold head, and thus it is possible to embody the superconducting cooling method by conduction and also rapidly respond to a momentary temperature change.

1. A superconducting rotating machines cooling apparatus using a heating pipe, comprising:
a shaft fitted and coupled into a center of a central body;
a stator yoke coupled to a periphery of the central body;
a superconducting coil wound on a bobbin mounted on the stator yoke; and
a cold head for cooling the superconducting coil coupled to an end of the shaft,
wherein the heating pipe is installed at one or multiple surfaces of all surfaces of the bobbin on which the superconducting coil is wound or at a winding portion of the superconducting coil so that temperature at the whole bobbin is uniformly distributed.

2. The superconducting rotating machines cooling apparatus of claim 1, wherein the heating pipe is installed at multiple surfaces of all surfaces of the bobbin on which the superconducting coil is wound.
